(19) United States
(12) Patent Application Publication
(10) Pub. No.: US 2025/0153994 A1
(43) Pub. Date: May 15, 2025

(54) PORTABLE WATER PURIFICATION AND DISPENSING DEVICE

(71) Applicant: The Last Kilometer Corp., Sterling Heights, MI (US)

(72) Inventor: Jaron Rothkop, Ann Arbor, MI (US)

(21) Appl. No.: 18/945,699

(22) Filed: Nov. 13, 2024

Related U.S. Application Data
(60) Provisional application No. 63/598,338, filed on Nov. 13, 2023.

(51) Int. Cl. B67D 1/00; B67D 1/08

(52) U.S. Cl. CPC B67D 1/0014; B67D 1/0888; B67D 1/0889; B67D 2210/0001; B67D 2210/00015; B67D 2210/00039; B67D 2210/00139

(57) ABSTRACT

An example water dispensing device includes a housing that includes a water inlet and a water outlet that are fluidly connected to each other through one or more intermediate components in the housing. The one or more intermediate components include at least one of a water treatment device and a water filter. A hand truck of the water dispensing device includes a pair of wheels and a base and a rear wall that are angled with respect to each other. The base and the rear wall are part of the housing. A method is also disclosed.

### RELATED APPLICATIONS

This application claims the benefit of U.S. Provisional Application No. 63/598,338, filed Nov. 13, 2023, the disclosure of which is incorporated by reference herein in its entirety.

### TECHNICAL FIELD

The present disclosure relates to devices for purification and dispensing of water.

### BACKGROUND

Many communities and institutions are served by water systems contaminated with lead, arsenic, bacteria, and other contaminants that are harmful to human health. Although permanent water purification and delivery systems are known, in many instances, it is not feasible to install such systems in sufficient time to meet the population's needs for potable water, especially when such systems are only needed for temporary use.

### SUMMARY

A water dispensing device according to an example embodiment of the present disclosure includes a housing that includes a water inlet and a water outlet that are fluidly connected to each other through one or more intermediate components in the housing. The one or more intermediate components include at least one of a water treatment device and a water filter. A hand truck of the water dispensing device includes a pair of wheels and a base and a rear wall that are angled with respect to each other. The base and the rear wall are part of the housing.

In a further embodiment of the foregoing embodiment, the one or more intermediate components include a water treatment device and at least one water filter.

In a further embodiment of any of the foregoing embodiments, the water treatment device is an ultraviolet water treatment device.

In a further embodiment of any of the foregoing embodiments, the one or more intermediate components include a first water filter and a second water filter. The first water filter and second water filter are separate from each other and are different types of water filters.

In a further embodiment of any of the foregoing embodiments, the housing has an inner cavity at least partially defined by a front wall and the rear wall. The one or more intermediate components are disposed in the inner cavity. The water dispensing device includes a removable access panel, and removal of the removable access panel provides access to the one or more intermediate components in the inner cavity.

In a further embodiment of any of the foregoing embodiments, a water bottle filling station is disposed on a front wall of the housing or in an opening of the front wall. The water outlet is an outlet of the water bottle filling station.

In a further embodiment of any of the foregoing embodiments, the water dispensing device includes a battery configured to power the water bottle filling station and at least one photovoltaic cell configured to charge the battery.

In a further embodiment of any of the foregoing embodiments, the water dispensing device includes an electrical connector accessible from an exterior of the water dispensing device. The electrical outlet is powered by the battery and is configured to power one or more external devices.

In a further embodiment of any of the foregoing embodiments, the water inlet is a first water inlet and the water outlet is a first water outlet. The water dispensing device includes a second water inlet configured to receive wastewater from the water bottle filling station and a second water outlet that is fluidly connected to the second water inlet and is configured to dispense the wastewater.

In a further embodiment of any of the foregoing embodiments, the water dispensing device includes a camera having a field of view that includes an area outside the water dispensing device.

A method according to an example embodiment of the present disclosure includes, with a water dispensing device in a first position, connecting a water source to a water inlet of the water dispensing device, the water inlet in fluid communication with a water outlet, the water dispensing device includes a base and a rear wall that are angled with respect to each other, and a pair of wheels. The method also includes purifying the water between the water inlet and the water outlet. The purifying includes at least one of filtering the water with at least one water filter and treating the water with a water treatment device. The method also includes dispensing the water through the water outlet, and, with the water dispensing device in a second position that is more tilted than the first position, transporting the water dispensing device to a water dispensing location. The transporting utilizes the base, rear wall, and pair of wheels as a hand truck.

In a further embodiment of the foregoing embodiment, the filtering includes performing first filtering of the water with a first water filter and, subsequent to the first filtering, performing second filtering of the water with a second water filter. The first water filter and the second water filter are separate from each other and are different types of water filters.

In a further embodiment of any of the foregoing embodiments, the dispensing includes dispensing the water through a water bottle filling station that is part of the water dispensing device.

In a further embodiment of any of the foregoing embodiments, the method includes harvesting energy through at least one photovoltaic cell, charging a battery using the battery, and powering the water bottle filling station using power from the battery.

In a further embodiment of any of the foregoing embodiments, the method includes tilting the water dispensing device backwards from the first position to the second position. The tilting includes rotating the water dispensing device about an axis of rotation of the two wheels. The method also includes tilting the water dispensing device upwards from the second position to the first position at the water dispensing location. The water dispensing device includes a handle, and the handle is utilized in the tilting steps and the transporting step.

In a further embodiment of any of the foregoing embodiments, the water dispensing device has an inner cavity disposed between a front wall and a rear wall. The water treatment device and at least one filter are disposed in the inner cavity. The method includes opening an access panel of the water treatment device to access the inner cavity.

In a further embodiment of any of the foregoing embodiments, the method includes utilizing a camera secured to the water dispensing device to record images of an external environment of the water dispensing device and performing at least one of: saving the images in memory of the water dispensing device and wirelessly transmitting the images to an external computing device.

A water dispensing device according to an example embodiment of the present disclosure includes a housing. The housing includes a water inlet and a water outlet that are fluidly connected to each other through one or more intermediate components. The one or more intermediate components include at least one of a water treatment device and a water filter. The water dispensing device also includes a pair of wheels secured to the housing and configured for transporting the water dispensing device when the water dispensing device is in a tilted position.

In a further embodiment of the foregoing embodiment, the pair of wheels rotate about a shared axis of rotation, and are spaced apart from each other along the shared axis of rotation. The water dispensing device is configured to rotate about the shared axis of rotation from an upright position to the tilted position.

In a further embodiment of any of the foregoing embodiments, the water dispensing device includes a water bottle filling station secured to the housing, and the water outlet is an outlet of the water bottle filling station.

The embodiments, examples, and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

### BRIEF DESCRIPTION OF THE DRAWINGS

FIG. 1 illustrates a front perspective view of an example portable water treatment and dispensing device.

FIG. 2 illustrates a rear perspective view of the device of FIG. 1.

FIG. 3A illustrates the device of FIG. 1 in an example upright position.

FIG. 3B illustrates the device of FIG. 1 in a tilted position.

FIG. 4 illustrates internal components the device of FIG. 1.

FIG. 5 illustrates an example arrangement of internal plumbing components for the device of FIG. 1.

FIG. 6 is a flowchart of an example method.

FIG. 7 illustrates optional additional components that may be included as part of the device of FIG. 1.

FIG. 8 illustrates an electrical schematic of the device of FIG. 1 for a first configuration that does not utilize a battery to power the device.

FIG. 9 illustrates an electrical schematic of the device of FIG. 1 for a second configuration in which a battery is used to power the device.

FIG. 10 illustrates an electrical schematic for the device of FIG. 1 that includes optional components illustrated in FIG. 7 and additional optional components.

FIG. 11 illustrates an example control panel layout for the electrical schematic in FIG. 8.

### DETAILED DESCRIPTION

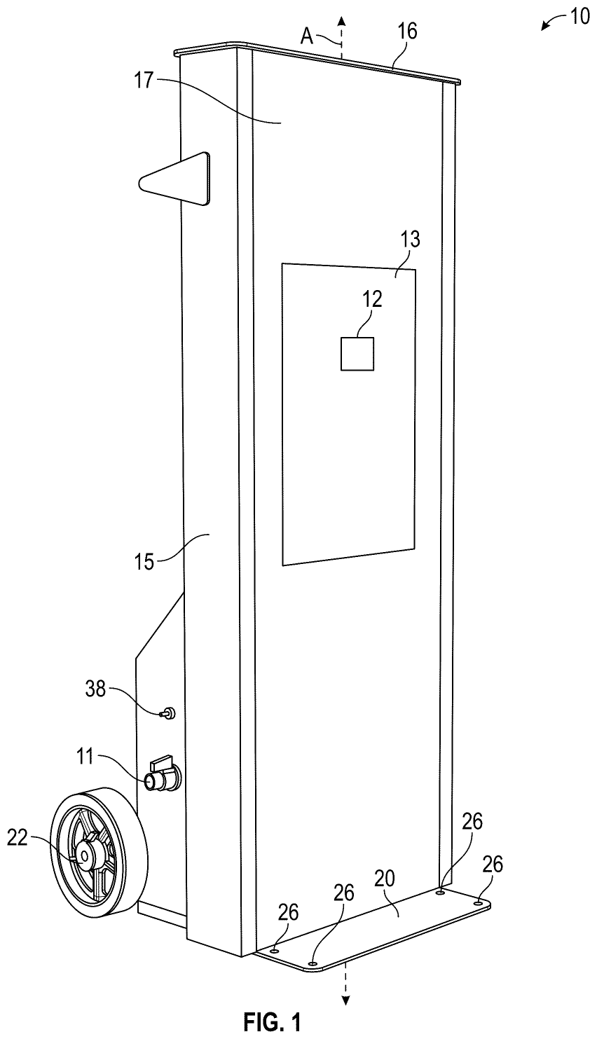

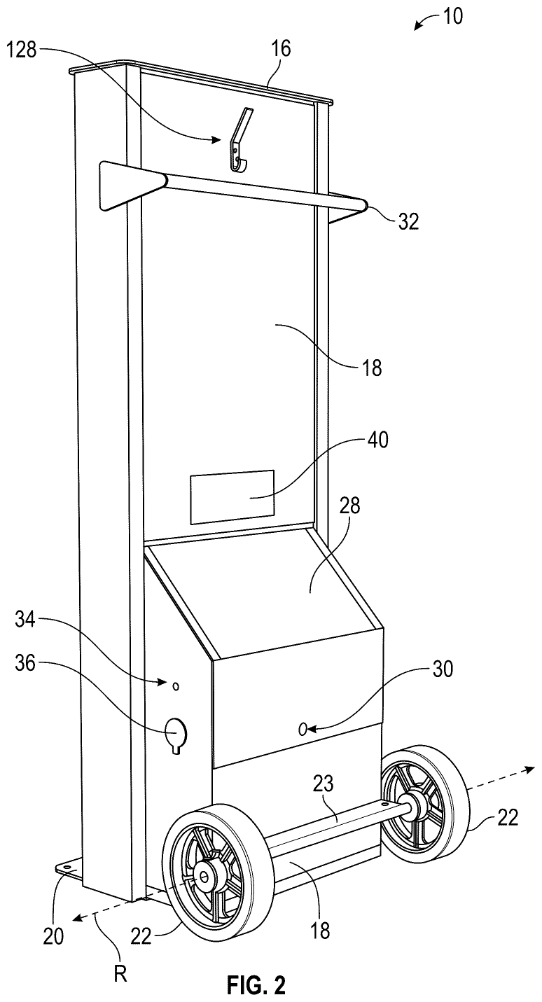

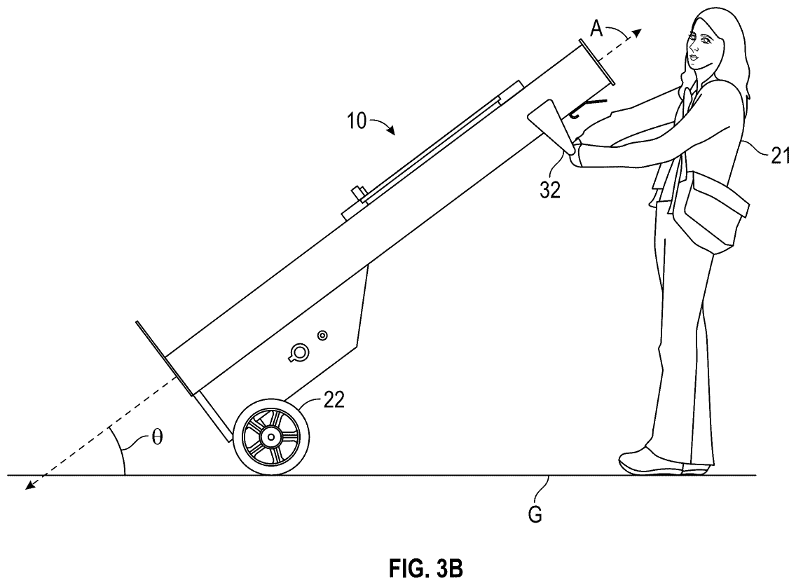

FIG. 1 illustrates a front perspective view of an example water purification and dispensing device 10 (hereinafter “the device”), and FIG. 2 illustrates a rear perspective view of the device 10. The device 10 is portable and includes water purification features in the form of a least one of a water treatment device 46 and one or more water filters 44 (see FIG. 4) disposed within a housing 15 of the device 10. The device 10 extends along a central longitudinal axis A between a top cap 16 and a base plate 20.

The device 10 includes an external housing 15 that includes a water inlet 11 (e.g., an inlet valve) and a water outlet 12 (of a dispenser 13). The water inlet 11 and water outlet 12 are fluidly connected to each other through one or more intermediate components in the housing 15. The one or more intermediate components include at least one of a water treatment device and one or more water filters (i.e., a water treatment device, one or more water filters, or both a water treatment device and one or more water filters).

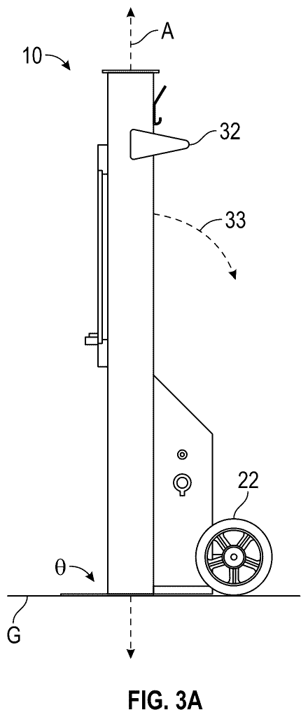

The water inlet 11 is configured to be fluidly connected to an external pressurized water source 19 (see FIG. 3), and once connected, the device 10 receives water from the water source 19, processes the water through for purification, and dispenses the purified water through the water outlet 12.

Referring to FIGS. 1-2, the device 10 includes an external housing 15, which includes the top cap 16, a front wall 17, a rear wall 18, and the base plate 20. The rear wall 18 and base plate 20 are angled with respect to each other (e.g., are substantially perpendicular to each other). The device 10 also includes a pair of wheels 22 and a handle 32. The handle 32 may be mounted, e.g., at or above eye level (e.g., 4-6 feet) to facilitate transportation of the device 10. The wheels 22 are provided proximate to the base plate 20, rotate about a shared axis of rotation R, and are spaced apart from each other along the axis R. As will be described below in greater detail, the pair of wheels 22, the base plate 20, and the rear wall 18 act as a hand truck for transporting the device 10 when the device 10 is in a tilted position.

The device 10 may be installed on a temporary basis, and when connected to existing water lines that provide contaminated water, will treat the contaminated water and deliver purified, potable water (e.g., using a bottle filler). The device 10 may be used as a temporary replacement for a permanently-mounted water filtration system and bottle filler and/or for use in locations where the installation of a permanently-mounted water filtration system and bottle filler is unfeasible.

FIG. 3A illustrates the device 10 in an example first position, which is an upright position, and FIG. 3B illustrates the device 10 an example second position, which is a tilted position. In each of FIGS. 3A and 3B, the device 10 is disposed on a ground plane G, but in the tilted position of FIG. 3B, the base plate 20 is elevated off of the ground plane G.

In the tilted position of FIG. 3B, an angle Θ of intersection between the central longitudinal axis A and the ground plane G has a first value that is less than 90°, and in the upright position of Figure A, the angle Θ has a second value, that is greater than the first value, and that in the example of Figure A is substantially 90°. Although only one tilted position is depicted, it is understood that a variety of angles Θ could be used for a variety of tilted positions (e.g., between) 25°-65°, and that the precise angle is likely to vary as the device 10 is being transported using its built-in hand truck features.

The device 10 is configured to rotate about the shared axis of rotation R from the upright position to the tilted position for transportation. A user 21 may use the handle 32 to tilt the device 10, as shown with arrow 33, from the upright position to the tilted position in which the wheels 22 are on the ground and the base plate 20 is elevated off the ground, for wheeling/transporting the device 10. The axis of rotation R of the wheels 22 may be, e.g., up to 8 inches from the ground plane G so that the device 10 may be tipped backwards for transport. Thus, the pair of wheels 22, base plate 20, and rear wall 18 act as a hand truck for transporting the device 10 when the device 10 is in a tilted position.

Referring again to FIGS. 1-2, the external housing 15 may be fabricated from durable materials such as aluminum, steel, or plastic, for example, and may be coated to prevent damage from outdoor exposure. The external housing 15 may be fabricated from formed components and/or molded components and assembled using fasteners and/or welding, for example. The front wall 17 and rear wall 18 of the device 10 may be made from a material that is resilient to deformation, such as ABS plastic.

The base plate 20 provides stability and prevents the device 10 from tipping over during normal use, when the device 10 is in the upright position. The base plate 20 in the example of FIG. 1 includes one or more through-holes 26 that may be used to secure the device 10 to a support (e.g., flooring) for the purpose of preventing theft and unauthorized use of the device 10. The device 10 also includes a retaining hook 128 which may be used to retain hoses during transport and also may be used as a retention point for a security tether which may connect the device to a stationary mounting point using, e.g., a wire to prevent the accidental tipping of the device 10.

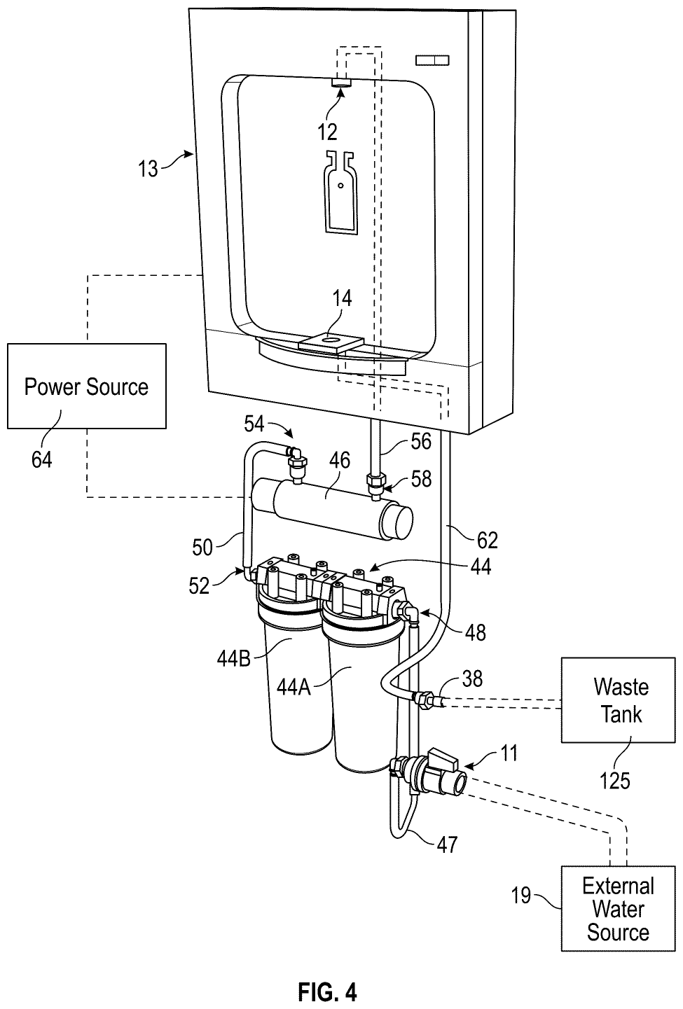

As shown in FIG. 2, the housing 15 includes an access panel 28 which, when removed, provides access to an inner cavity 53 of the housing (see FIG. 5) and water purification components therein (e.g., for maintenance). In the example of FIG. 2, the access panel 28 forms a portion of the rear wall 18. The access panel 28 may include a keyed lock 30 to prevent unauthorized access. The pair of wheels 22 may be mounted to the rear wall 18 (e.g., at the furthest rearward point) to aid in stabilizing and transporting the device 10. In the example of FIG. 2, the wheels 22 share a common axle 23 and rotate about a longitudinal axis of the axle 23 (which is the shared axis of rotation R). The wheels 22 may be of the internal bearing type (e.g., Wesco Industrial Products 8″ Cast Iron Center Moldon Rubber Wheel for Vending Machine and Heavy-Duty Hand Trucks) and may be mounted to a stationary rod in place of axle 23.

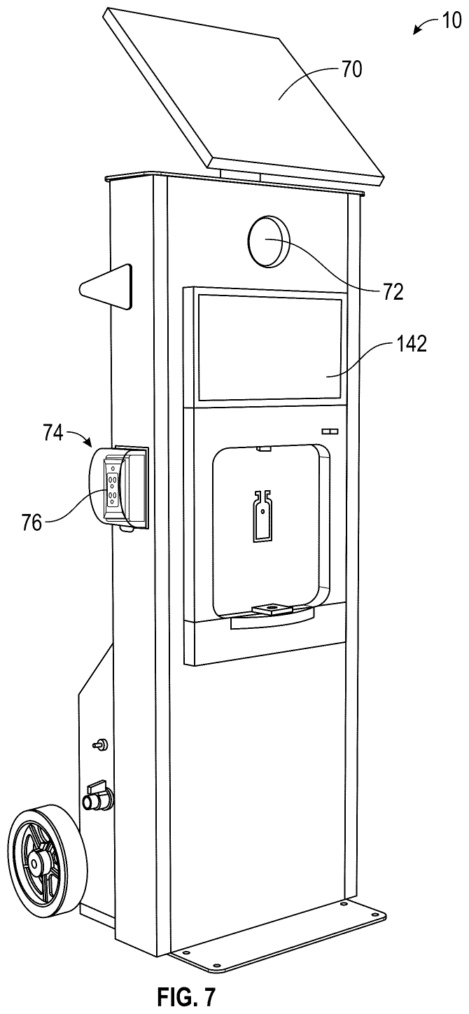

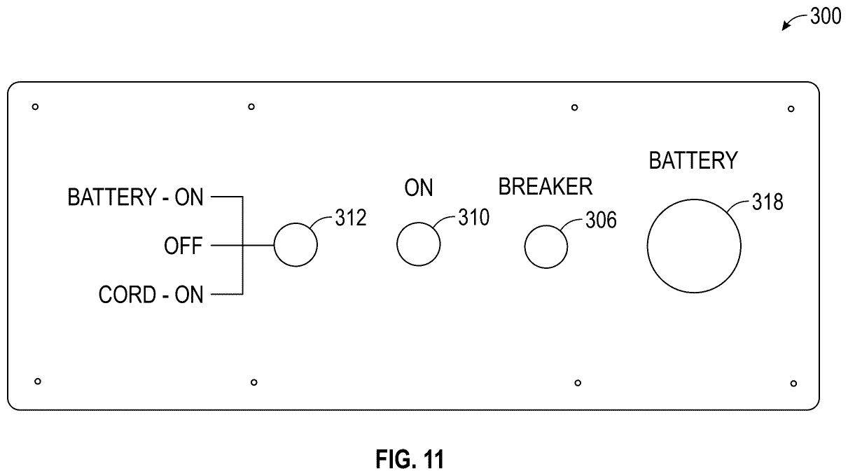

FIG. 2 illustrates several of the device's external interfaces. Referring to FIG. 2, with continued reference to FIG. 1, an external battery disconnect switch 34 provides for turning a circuit of the device 10 ON or OFF. The disconnect switch 34 may include a waterproof cover that protects an internal battery 110 (see, e.g., FIG. 8) from discharging when not in use (e.g., a PICO 5588 PT Waterproof On-Off SPST Toggle Switch). An electrical connector 36 (e.g., a power inlet) may be used to facilitate connection of the device 10 to an external power source and may include a waterproof cover with the appropriate configuration for the service territory, such as NEMA 15-5 for standard USA power which accommodates a standard NEMA 15-5 extension cord, and/or may be used to power external devices from a battery of the device 10. The water inlet 11 controls the flow of water into the device 10 from the external water source 19, and may accept adapters to the appropriate type for connection to the external source, which may include a garden hose (GHP) or ⅜ universal supply line connection. An external control panel 40 provides a location for mounting controls and/or indicators for configuring the device 10 (see also FIG. 11).

FIG. 4 illustrates an example plumbing layout of the device 10, in which the dispenser 13 is a water bottle filling station (or “bottle filler”), such that the water outlet 12 is an outlet of the water bottle filling station. The bottle filler 13 is secured to the housing 15, and is disposed on the front wall 17 of the housing, or in an opening of the front wall 17, and may be used to dispense water into water bottles or other containers. The bottle filler 13 delivers pressurized water when activated. Examples of compatible bottle fillers include Elkay Mechanical Surface Mount Bottle Refilling Station, Non-Electric and Elkay EZH2O Stainless Steel Water Bottle Refilling Station w/Filter, Surface Mount. Although the bottle filler 13 may be powered or unpowered, FIG. 4 depicts a powered configuration. As shown in FIG. 3, the water inlet 11 is fluidly connected to the outlet 12 through the intermediate components of filters device 44A-B and a water treatment device 46 (e.g., an ultraviolet treatment device). In the example of FIG. 3, the one or more filters 44 includes two filters 44A-B, which are separate from each other and may be different filters that provide stages of filtration (e.g., first filtering by filter 44A followed by second filtering by filter 44B). Some alternatives to the bottle filler may include a water filler (e.g., a goose neck water filler), for example. A waste drain 14 (see FIG. 4) may be provided for draining wastewater (e.g., non-bottled water) from the bottle filler.

In one example, the filters includes the first filter 44A, which is a membrane prefilter for capturing sediment, and also includes the second filter 44B which is configured to remove remaining contaminants (e.g., lead, VOC, cyst, chlorine and/or odor). The first filter 44 maybe selected as appropriate for the particulate levels of the source water. In one example, a Pentek 10″ Slim Line Water Filter Housing may be used to house the first filter 44A, and the first filter 4A may be a Pentair WP-5 String Wound Polypropylene 5 Micron Filter. In one example, the second filter 44B is a Matrikx +Pb1 Lead, VOC, Cyst, Chlorine Taste & Odor Filter. Although FIG. 3 depicts a particular configuration, it is understood that other configurations may be used that include a greater or lesser number of filters and the addition or replacement of the membrane filters with other filtration devices, for example a reverse osmosis filter or water ionizer.

As discussed above, water enters the device 10 through the water inlet 11. A first tube 47 fluidly connects the water inlet 11 to a filter inlet 48. A second tube 50 fluidly connects an outlet 52 of the filter 44 to an inlet 54 of the treatment device 46. A third tube 56 fluidly connects an outlet 58 of the treatment device 46 to the water outlet 12. One or more, or all three, of the tubes 47, 50, 56 maybe flexible tubes.

The water treatment device 46 is configured to kill biological contaminants that may remain in the water, and may be an ultraviolet filter (e.g., the Viqua VTI Copper Series UV System), for example. Alternatively, the water treatment device 46 may be an ozone water treatment device, for example.

The bottle filler 13 may be powered or unpowered. Examples of compatible bottle fillers include Elkay Mechanical Surface Mount Bottle Refilling Station, Non-Electric and Elkay EZH2O Stainless Steel Water Bottle Refilling Station w/Filter, Surface Mount. The waste drain 14 is fluidly connected to an external drain outlet 38 through a fourth tube 62, which also may be a flexible tube. A power source 64 (e.g., an internal battery or external AC power source) may be used to power the bottle filler 13 and/or the water treatment device 46. The external drain outlet 38 is configured for draining wastewater from the dispenser 13, which may be collected in an external tank 125 or redirected to an external waste drain, for example. In the example of FIG. 4, the water inlet 11 is a first water inlet, the water outlet 12 is a first water outlet, and the waste drain 14 is a second water inlet configured to receive wastewater from the water bottle filling station, and the external drain outlet 38, which is fluidly connected to the waste drain 14, is configured to dispense the wastewater.

FIG. 5 illustrates the device 10 with the rear wall 18 the access panel 28 and a portion of the rear wall 18 removed, to depict various ones of the internal plumbing components of FIG. 4 in the inner cavity 53. The inner cavity 53 is at least partially defined by the front wall 17 and the rear wall 18, and the water treatment device 43 and one or more filter(s) 44 are disposed in the inner cavity 53, such that removal of the removable access panel 28 provides access to the one or more intermediate components within the inner cavity 53. The plumbing components shown in FIGS. 4-5 may be mounted on a backplate or directly to the device housing using conventional fasteners such as 10/24 screws and locknuts, for example.

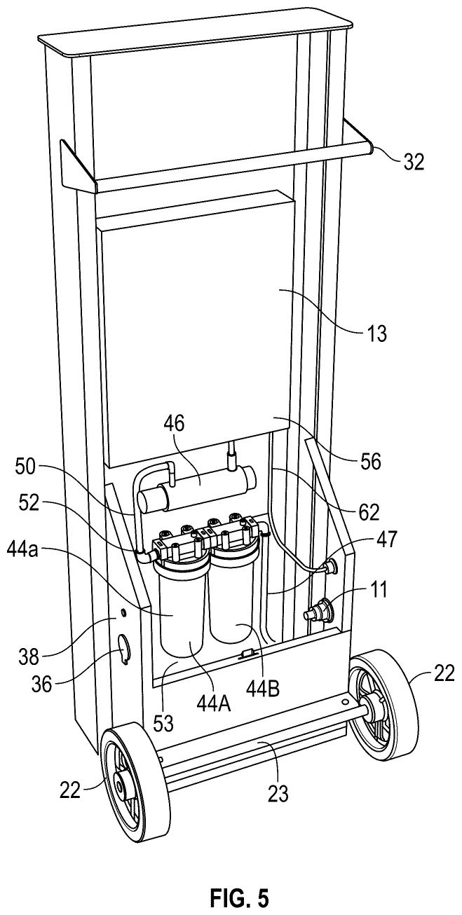

FIG. 6 is a flowchart of an example method 200. A built-in hand truck, which includes wheels 22, base plate 20, and rear wall 18, and is integrated into a water dispensing device (e.g., the device 10) is utilized to transport the device to a water dispensing location (step 202). Step 202 is performed while the device 10 is in the tilted position (e.g., corresponding to FIG. 3A). The device 10 is tilted upwards to an upright position (e.g., corresponding to FIG. 3A) at the water dispensing location (step 204). An external water source 19 is connected to a water inlet 11 of the device 10, which is in fluid communication with the water outlet 12 of the device 10 (step 206). Water from the external water source 19 is purified between the water inlet 11 and the water outlet 12 through filtration and/or water treatment (step 208), and the purified water is dispensed through the water outlet 12 (step 210).

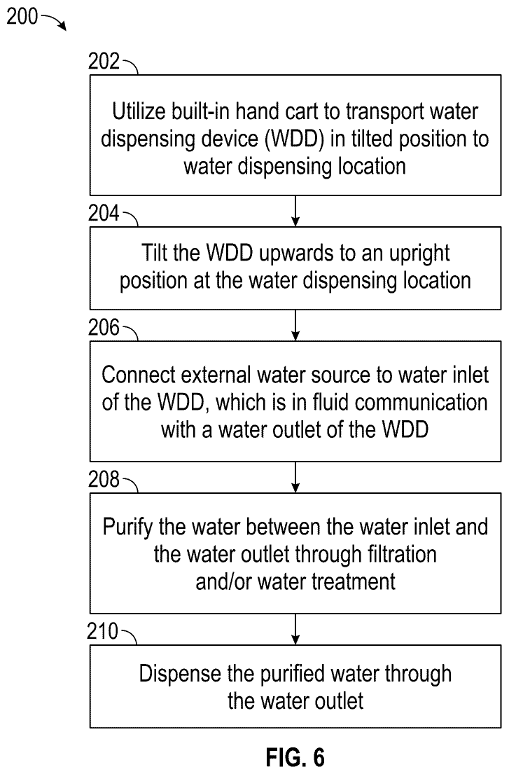

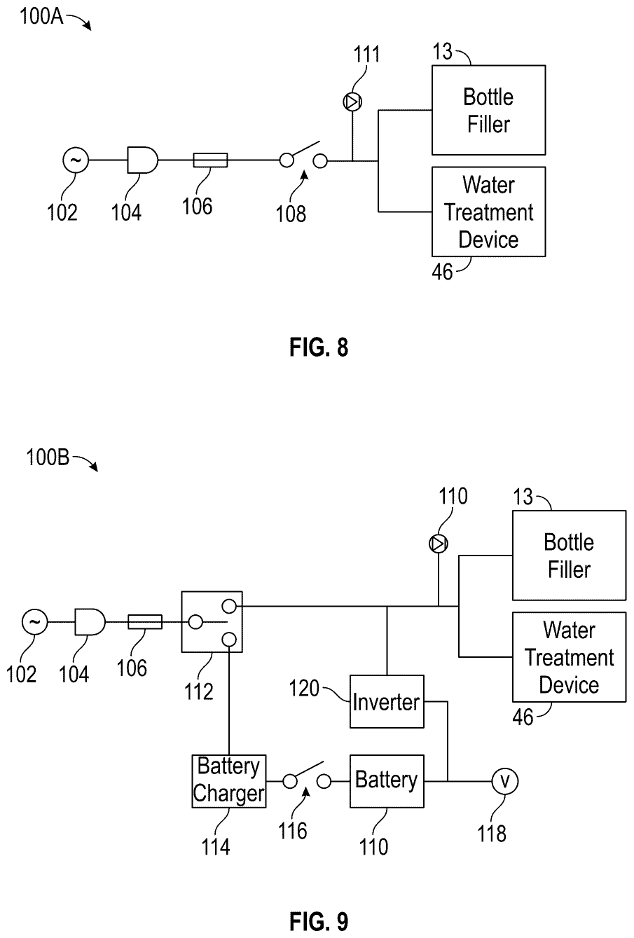

FIG. 7 illustrates optional additional components that may be included as part of the device 10, either individually or in any combination. A solar module 70 includes at least one photovoltaic cell for harvesting and converting solar energy to electrical power for charging a battery 110 (see, e.g. FIG. 9) within the device 10. The battery 110 may be used for powering the water bottle filling station of FIG. 4, or powering an electrical connector 74 as a power outlet, for example (e.g., for charging mobile devices through a low voltage DC connection, such as USB). The electrical connector 74 is accessible from an exterior of the device 10, and is configured to power one or more external devices.

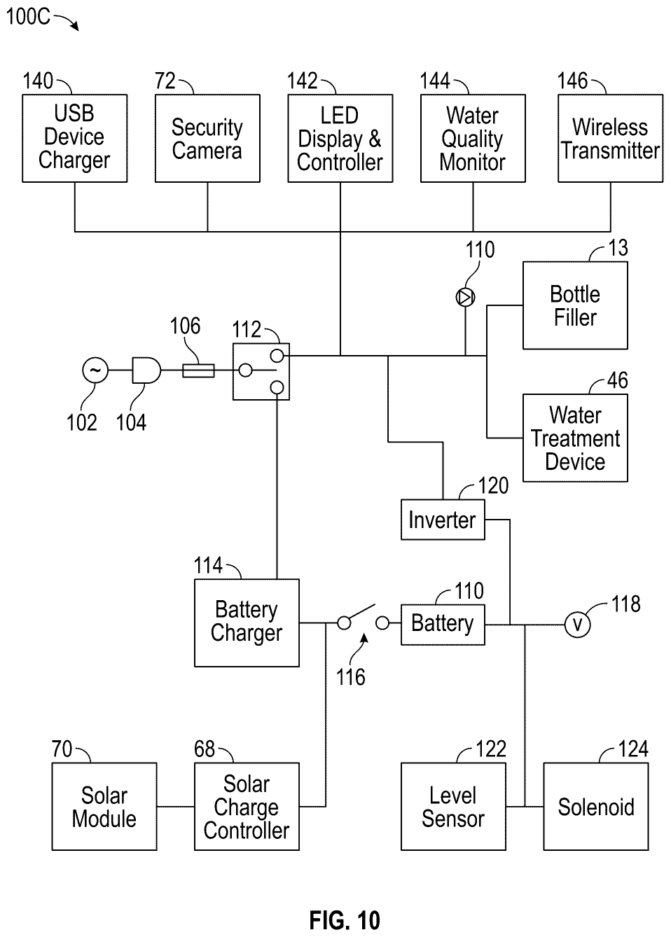

A security camera 72 has a field of view that includes an area outside of the device 10. The security camera 72 is configured to record images (e.g., still images and/or video) of an environment surrounding the device 10, which may serve as a theft/tampering deterrent and/or may be used to activate the device 10 when presented with an image such as a QR code. The device 10 may include internal memory (not shown) for saving the images and/or a wireless transmitter 146 for transmitting the images (see FIG. 10), for example. As discussed above, the electrical connector 74 may be configured as a device charger for charging devices (e.g., mobile phones) through one or more electrical ports (e.g., traditional electrical outlets, USB ports, etc.) from the battery 110 and/or an external power source. In the example of FIG. 5, the device charger 74 includes a waterproof cover 76. An electronic display 142 may be provided for presenting information to users of the device 10 (e.g., status of the device 10, status of the battery 110, etc.).

FIG. 8 illustrates an electrical schematic 100A for a first configuration of the device 10 that does not utilize a battery to power the device 10. Power from an AC power source 102 is supplied to the device 10 through an external connection 104 (e.g., an electrical outlet), which may be, e.g., a NEMA 15-5 shore power plug. A short-circuit protection device 106 (e.g., a fuse or resettable breaker) is configured to prevent a short-circuit of the device 10. An on/off switch 108 is used to turn the device 10 ON or OFF. When the switch 108 is in the ON position, an indicator lamp 111, which may be of an LED variety, notifies a user that the device 10 is ready for use and that the bottle filler assembly 60 and water treatment device 46 are receiving power.

FIG. 9 illustrates an electrical schematic 100B for a second configuration of the device 10 that is powered by a battery 110 (e.g., for remote utilization when an AC power source is unavailable). In addition to the elements 102, 104, 106, 60, 46 of FIG. 8, the configuration of FIG. 9 includes a three-way switch 112 for an operator to select between being powered by the battery 110 or being powered through the electrical connection 104. Electrical power from the AC power source 102 is directed to a battery charger 114 which converts AC from the AC power source 102 to DC for charging the battery 110. A battery shut-off switch 116 is provided to selectively disconnect the battery 110 from the charger 114 (e.g., to prevent the battery from draining during storage and protect the device during transportation). The battery 110 may be of a range of types, for example, a flooded wet-cell battery such as an ACDelco Advantage Battery Group Size 34, an OPTIMA BlueTop AGM Spiralcell Marine Battery, or a Deep Cycle Lithium-Ion Dual Terminal RV Battery, and battery voltage may be 12-48V DC. A battery meter 118 with a display may be connected to the battery 110 to inform an operator of the battery's health (e.g., charge level) using a visual indicator and/or display of battery voltage. AC power for the internal components is provided by means of an inverter 120 of appropriate voltage for the battery type, such as a Xantrex PROwatt SW.

FIG. 10 illustrates an electrical schematic 100C of the device 10 in a third configuration that powers additional components as compared to the first and second configurations of FIGS. 8-9. A solar module 70, which includes one or more photovoltaic cells, may be used to charge the battery 110 through a solar charge controller 68 of appropriate voltage for the battery. To contain overflow fluid from the waste drain 14, the device 10 may include or be connectable to a removable waste tank 125 (see FIG. 4). To prevent continued use when the waste tank 125 is full, a water level sensor 122 such as a Moeller reed switch may be placed in the waste tank that shuts off the flow of water using a motorized valve 124 such as a Mercury Marine Solenoid 89-96158 when the water level sensor detects that the waste tank 125 is full. The device 10 is configured in FIG. 8 to collect data concerning water quality using a water quality monitor 144 and to transmit this data to a remote location for analysis using wireless transmitter 146. The wireless transmitter 146 may also be used to transmit images and/or video recorded by camera 72.

Accessories that may be included with device 10 include a USB mobile device charger 140 (which may provide an outlet as part of the device charger 74), the security camera 72 which may be used for image recognition or as a security apparatus, an electronic display 142 (optionally also a controller) which may present information to users of the device 10, the electronic display 142 (optionally also a controller) which may present information to users of the device 10, a water quality monitor 144 which may collect information about the water passing through the system and detect leaks, and a wireless transmitter 146 which may transmit information about the device 10, such as water quality or leaks to a central location for monitoring. In FIG. 10, these accessories are shown connected to the AC electrical system, but it is understood that they may alternately be connected to the DC power system.

As described in the examples above, device 10 may be used to treat non-potable water sources by removing a number of organic and inorganic contaminants so that the water becomes potable. The device 10 may connect to a variety of water source fixtures and be operable in the absence of a fixed electrical power source. The device 10 may be able to be moved by a single person and has features to deter theft, accidental tipping, and unauthorized misuse of the device. The device 10 may be used indoors by directing wastewater to a waste container or external drain and additionally used outdoors by directing wastewater to an appropriate location outside the device.

FIG. 11 illustrates an example control panel layout 300 for the control panel 40 of FIG. 2, and which is compatible with the device 10 schematic in FIG. 9. Element 312 indicates a status of the three-way switch 112. Element 310 indicates a status of the internal battery 110. Element 306 indicates a status of the short-circuit protection device 106. Element 318 indicates an output of the battery meter 118. The elements 312, 310, 306 may include LEDs, for example, while the element 318 may include a digital readout (e.g., a battery state of charge percentage).

Although example embodiments have been disclosed, a worker of ordinary skill in this art would recognize that certain modifications would come within the scope of this disclosure. For that reason, the following claims should be studied to determine the scope and content of this disclosure.

What is claimed is:

1. A water dispensing device, comprising:
a housing that includes a water inlet and a water outlet that are fluidly connected to each other through one or more intermediate components in the housing, the one or more intermediate components including include at least one of a water treatment device and a water filter; and
a hand truck including:
a pair of wheels; and
a base and a rear wall that are angled with respect to each other, wherein the base and the rear wall are part of the housing.

2. The water dispensing device of claim 1, wherein:
the one or more intermediate components include a water treatment device and at least one water filter.

3. The water dispensing device of claim 1, wherein the water treatment device is an ultraviolet water treatment device.

4. The water dispensing device of claim 1, wherein:
the one or more intermediate components include a first water filter and a second water filter, wherein the first water filter and second water filter are separate from each other and are different types of water filters.

5. The water dispensing device of claim 1, wherein:
the housing has an inner cavity at least partially defined by a front wall and the rear wall;
the one or more intermediate components are disposed in the inner cavity;
the water dispensing device includes a removable access panel; and
removal of the removable access panel provides access to the one or more intermediate components in the inner cavity.

6. The water dispensing device of claim 1, comprising:
a water bottle filling station disposed on a front wall of the housing or in an opening of the front wall;
wherein the water outlet is an outlet of the water bottle filling station.

7. The water dispensing device of claim 6, comprising:
a battery configured to power the water bottle filling station; and
at least one photovoltaic cell configured to charge the battery.

8. The water dispensing device of claim 7, comprising:
an electrical connector accessible from an exterior of the water dispensing device, wherein the electrical outlet is powered by the battery and is configured to power one or more external devices.

9. The water dispensing device of claim 6, wherein:
the water inlet is a first water inlet;
the water outlet is a first water outlet; and
the water dispensing device includes:
a second water inlet configured to receive wastewater from the water bottle filling station; and
a second water outlet that is fluidly connected to the second water inlet and is configured to dispense the wastewater.

10. The water dispensing device of claim 6, comprising:
a camera having a field of view that includes an area outside the water dispensing device.

11. A method, comprising:
with a water dispensing device in a first position:
connecting a water source to a water inlet of the water dispensing device, the water inlet in fluid communication with a water outlet, the water dispensing device including a base and a rear wall that are angled with respect to each other, and a pair of wheels;
purifying the water between the water inlet and the water outlet, the purifying comprising at least one of:
filtering the water with at least one water filter; and
treating the water with a water treatment device; and
dispensing the water through the water outlet; and
with the water dispensing device in a second position that is more tilted than the first position, transporting the water dispensing device to a water dispensing location, the transporting including utilizing the base, rear wall, and pair of wheels as a hand truck.

12. The method of claim 11, wherein the filtering comprises:
performing first filtering of the water with a first water filter; and
subsequent to the first filtering, performing second filtering of the water with a second water filter;
wherein the first water filter and the second water filter are separate from each other and are different types of water filters.

13. The method of claim 11, wherein:
the dispensing includes dispensing the water through a water bottle filling station that is part of the water dispensing device.

14. The method of claim 13, comprising:
harvesting energy through at least one photovoltaic cell;
charging a battery using the battery; and
powering the water bottle filling station using power from the battery.

15. The method of claim 11, comprising:
tilting the water dispensing device backwards from the first position to the second position, the tilting including rotating the water dispensing device about an axis of rotation of the two wheels; and
tilting the water dispensing device upwards from the second position to the first position at the water dispensing location;
wherein the water dispensing device includes a handle, and the handle is utilized in the tilting steps and the transporting step.

16. The method of claim 11, wherein:
the water dispensing device has an inner cavity disposed between a front wall and a rear wall;
the water treatment device and at least one filter are disposed in the inner cavity; and
the method includes opening an access panel of the water treatment device to access the inner cavity.

17. The method of claim 11, comprising:
utilizing a camera secured to the water dispensing device to record images of an external environment of the water dispensing device; and
performing at least one of:
saving the images in memory of the water dispensing device; and
wirelessly transmitting the images to an external computing device.

18. A water dispensing device, comprising:
a housing including a water inlet and a water outlet that are fluidly connected to each other through one or more intermediate components, wherein the one or more intermediate components include at least one of a water treatment device and a water filter; and
a pair of wheels secured to the housing and configured for transporting the water dispensing device when the water dispensing device is in a tilted position.

19. The water dispensing device of claim 18, wherein:
the pair of wheels rotate about a shared axis of rotation, and are spaced apart from each other along the shared axis of rotation; and
the water dispensing device is configured to rotate about the shared axis of rotation from an upright position to the tilted position.

20. The water dispensing device of claim 18, comprising:
a water bottle filling station secured to the housing, wherein the water outlet is an outlet of the water bottle filling station.
